(19) United States
(12) Patent Application Publication
(10) Pub. No.: US 2015/0370121 A1
(43) Pub. Date: Dec. 24, 2015

(54) COLOR FILTER SUBSTRATES AND LIQUID CRYSTAL DEVICES HAVING BLACK MATRIXES WITH VARIABLE WIDTHS

(71) Applicant: Shenzhen China Star Optoelectronics Technology Co. Ltd., Shenzhen, Guangdong (CN)

(72) Inventors: Chuan Wu, Shenzhen (CN); Jinbo Guo, Shenzhen (CN)

(21) Appl. No.: 14/370,775

(22) PCT Filed: Jun. 23, 2014
(86) PCT No.: PCT/CN2014/080541

§ 371 Date: Jul. 5, 2014

(51) Int. Cl. G02F 1/1335

(52) U.S. Cl. CPC G02F 1/133514; G02F 1/133512

(57) ABSTRACT

A CF substrate with black matrixes with variable widths is disclosed. The CF substrate is curved with black matrixes (BMs) arranged thereon, portions that are not covered by the BMs form subpixel display areas, wherein widths of the black matrixes increase gradually from a vertical-central axis of the CF substrate toward two sides of the CF substrate. In addition, a liquid crystal device is also disclosed. The misplacement between the CF substrate and the TFT substrate of the curved LCD can be overcome. In addition, the problem resulting from increasing the width of the black matrix, such as the decreased aperture ratio and brightness, may also be solved. The uniform displaying performance is mainly achieved by optical compensation of the backlight sheet; also, the cost is relatively low.

### BACKGROUND OF THE INVENTION

1. Field of the Invention

The present disclosure relates to a color filter substrate and more particularly to a color filter substrate and a liquid crystal display (LCD) having black matrixes with variable widths.

2. Discussion of the Related Art

FIG. 1 shows a conventional Thin Film Transistor Liquid Crystal Display (TFT-LCD) having one layer of black matrix (BM) 11 arranged at one side of a color filter (CF) substrate 10. However, for a curved LCD, the bent panel results in a misplacement between the CF substrate 10 and a Thin Film Transistor (TFT) substrate 20, i.e., a shift. In addition, the direction of the shift regarding the CF substrate 10 with respect to the TFT substrate 20 is not purely rightward or leftward. Two sides of the CF substrate 10 slide toward two sides of the TFT substrate 20. Thus, when the radius of the curvity is smaller, the curved degree of the panel is greater. Thus, the shift occurs at two sides of the CF substrate 10 and the TFT substrate 20 are also greater, which results in a smaller aperture ratio of the pixels located at two sides than that located in central area. In an example, a RGB pixel unit includes a R-subpixel, a G-subpixel, and a B subpixel arranged horizontally, and the BM 11 is arranged therebetween. After being shifted, the actual opening area equals to the original opening area deducting the area indicated by “c.” The “c” only indicate the shift amount, which is not a number, also, “c” shown in FIG. 1 may not be the same. Thus, the brightness of the pixel is smaller for the pixels located at two sides than that located in the central area. In brief, this is the so-called “dark mass, ” as shown in FIG. 2. If the radius of the curvity is decreased, the shift amount at two sides may increase, which may result in color shift (see FIG. 3). When the G-subpixel is displayed, as the shift amount in the central area is zero or relatively low, only the G-subpixel is displayed. For the left-side area, only partial areas of the G-subpixel and the B-subpixel, as shown by a black frame indicated by “e,” are bright. For the right-side area, only partial areas of the G-subpixel and R-subpixel, as shown by the black frame indicated by “f,” are displayed. Under the circumstance, the colors displayed are different due to the light leakage. Especially, it is obvious when the image includes only one color.

### SUMMARY

The object of the claimed invention is to overcome the problem of dark mass or color shift resulting from the misplacement between the CF substrate and the TFT substrate of the curved LCD.

In one aspect, a color filter (CF) substrate having black matrixes with variable widths includes: the CF substrate is curved with black matrixes (BMs) arranged thereon, portions that are not covered by the BMs form subpixel display areas, wherein widths of the black matrixes increase gradually from a vertical-central axis of the CF substrate toward two sides of the CF substrate.

Wherein widths of the subpixel display areas decrease gradually from a vertical-central axis of the CF substrate toward two sides of the CF substrate.

Wherein a plurality of areas with a fixed width are defined on the CF substrate from the vertical-central axis toward two sides, the width of the black matrix of a central area where the vertical-central axis located and the width of the black matrix of an area closest to the vertical-central axis remain the same, the width of the black matrix of an adjacent area is greater than that of the central area by an amount equaling to “a”, and the width of the black matrix of one area is greater than that of the adjacent area closer to the central area by the amount equaling to “a.”

Wherein the subpixels includes R-subpixel, a G-subpixel, and a B-subpixel.

Wherein the subpixels includes R-subpixel, a G-subpixel, a B-subpixel, and a W-subpixel.

In another aspect, a liquid crystal device includes: a curved color filter (CF) substrate, portions that are not covered by the BMs form subpixel display areas, wherein widths of the black matrixes increase gradually from a vertical-central axis of the CF substrate toward two sides of the CF substrate, and widths of the subpixel display areas decrease gradually from a vertical-central axis of the CF substrate toward two sides of the CF substrate.

Wherein a plurality of areas with a fixed width are defined on the CF substrate from the vertical-central axis toward two sides, the width of the black matrix of a central area where the vertical-central axis located and the width of the black matrix of an area closest to the vertical-central axis remain the same, the width of the black matrix of an adjacent area is greater than that of the central area by an amount equaling to “a”, and the width of the black matrix of one area is greater than that of the adjacent area closer to the central area by the amount equaling to “a.”

Wherein the liquid crystal device further includes a backlight sheet arranged in a backside of a liquid crystal cell for applying optical compensation toward corresponding areas.

Wherein the liquid crystal device further includes a backlight sheet arranged in a backside of a liquid crystal cell for applying optical compensation toward corresponding areas.

Wherein the subpixels includes R-subpixel, a G-subpixel, and a B-subpixel.

Wherein the subpixels includes R-subpixel, a G-subpixel, a B-subpixel, and a W-subpixel.

In view of the above, the misplacement between the CF substrate and the TFT substrate of the curved LCD can be overcome. In addition, the problem resulting from increasing the width of the black matrix, such as the decreased aperture ratio and brightness, may also be solved. The uniform displaying performance is mainly achieved by optical compensation by the backlight sheet; also, the cost is relatively low.

### BRIEF DESCRIPTION OF THE DRAWINGS

FIG. 1 is a schematic view showing the shift between the curved CF substrate and the TFT substrate.

FIG. 2 is a schematic view showing the dark mass occurred between the curved CF substrate and the TFT substrate.

FIG. 3 is a schematic view showing the color shift occurred between the curved CF substrate and the TFT substrate.

FIG. 4 is a schematic view showing the variable width of the BMs of different areas of the CF substrate in accordance with the first embodiment.

FIG. 5 is a schematic view showing different increased amount of the width of the BMs of the CF substrate in accordance with the first embodiment.

FIG. 6 is a schematic view showing the LCD in accordance with a first embodiment.

FIG. 7 is a schematic view showing the variable width of the BMs of different areas of the CF substrate in accordance with the second embodiment.

FIG. 8 is a schematic view showing different increased amount of the width of the BMs of the CF substrate in accordance with the second embodiment.

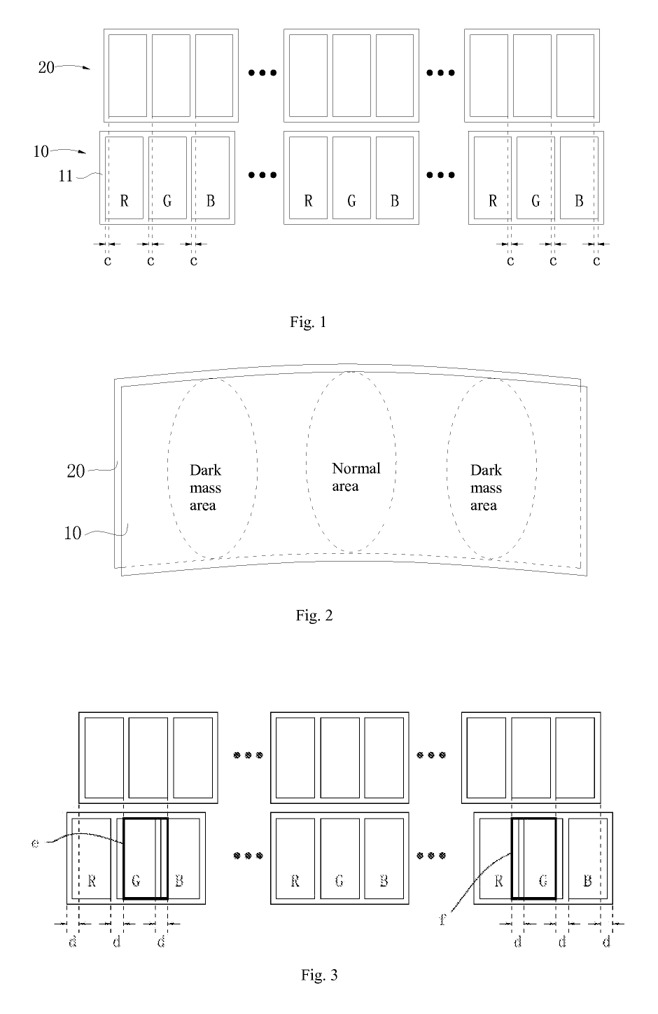

### DETAILED DESCRIPTION OF THE EMBODIMENTS

Embodiments of the invention will now be described more fully hereinafter with reference to the accompanying drawings, in which embodiments of the invention are shown.

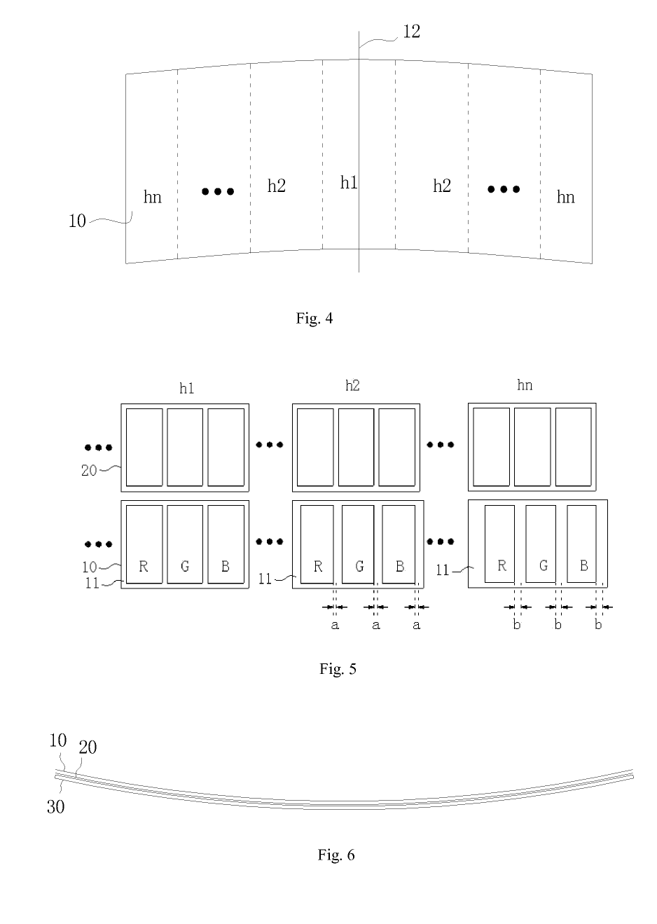

FIGS. 4-6 show the LCD in accordance with the first embodiment. The LCD includes TFT substrates 20 connected horizontally, and CF substrates 10 connected horizontally. The CF substrate 10 includes BMs 11 arranged thereon. The portions that are not covered by the BMs 11 are defined as subpixel display areas. When large-scale LCDs are manufactured, the vision difference results from the variable distance between users and different points of the LCD may be overcome by adopting a concave LCD. However, the dimension of pixels are fixed in conventional LCD manufacturing process. That is, the dimension of the subpixels and the BMs 11 surrounding the subpixels are respectively fixed. In an example, one subpixel includes a R-subpixel, a G-subpixel, and a B-subpixel arranged in parallel.

When the CF substrate 10 and the TFT substrates 20 are bent at the same time, the subpixels at two sides of the CF substrate 10 and the openings on the TFT substrate 20 are misplaced, which is referred to as “shift.” The shift may result in dark mass or color shift. In order to overcome the above-mentioned problem, one feasible solution is to increase the width of the BM 11. When the shift occurs, the BM 11 with greater width may still block the opening caused due to the subpixel has spanned over areas on the TFT substrate. As such, the color mixture caused by two displayed colors on the same TFT opening area is avoided.

It can be understood that when the CF substrate 10 is bent, the shift amount increases from a vertical-central axis 12 toward two sides. The dimension of one single pixel unit, including subpixels and black matrixes, remains and the width of the black matrix increases gradually. Correspondingly, the width of the display areas of the subpixels decreases gradually. A plurality of areas with a fixed width are defined on the CF substrate 10 from the vertical-central axis 12 toward two sides. In an example, the width of the black matrix of the central area hl remains the same. The width of the black matrix of an adjacent area h2 is increased by an amount of “a.” Similarly, the areas are defined in sequence from the central area toward two sides as h3, . . . , hm, where n is a natural number. The width of the black matrix of one area is greater than that of the adjacent area closer to the central area by the amount equaling to “a.” That is, the width of the black matrix of the area hn is increased by an amount of “b.”

When the width of the BM 11 is increased but the gap between the pixels remain, the displaying area of the subpixels is decreased and the aperture ratio is also decreased, which result in lower brightness. This may be solved by performing optical compensated via a backlight sheet 30 arranged in a backside of the liquid crystal cell. The degree of the optical compensation may be adjusted by aperture ratio. When the width of the black matrix is 30 g m, the width of the subpixel is 180 g m, the width of one subpixel unit equals to a sum of the width of the black matrix and the subpixel. That is, in the example, 210 μm. The aperture ratio of the area hl may be 85.7%, which is approximately 180/210. The real aperture ratio may be lower as the shading of the “com” line located in the central pixel and the shield metal areas have to be considered. For the areas h2 and hn, if the width of the black matrix has to be increased for the amount 5 μm and 10 μm, the aperture ratio of the h2 and hn are respectively 83.3% (175/210) and 81% (170/210=). The aperture ratios of the areas h2 and hn are less than that of the normal area, i.e., 85.7%, for amounts equaling to 2.4% and 2.7%. This may be solved by adopting the backlight sheet to proportionally compensate the corresponding backlight areas of the areas h2 and hn. In this way, the color shift and dark mass issues of the curved LCD may be overcome while the uniform brightness of the backlight module is guaranteed.

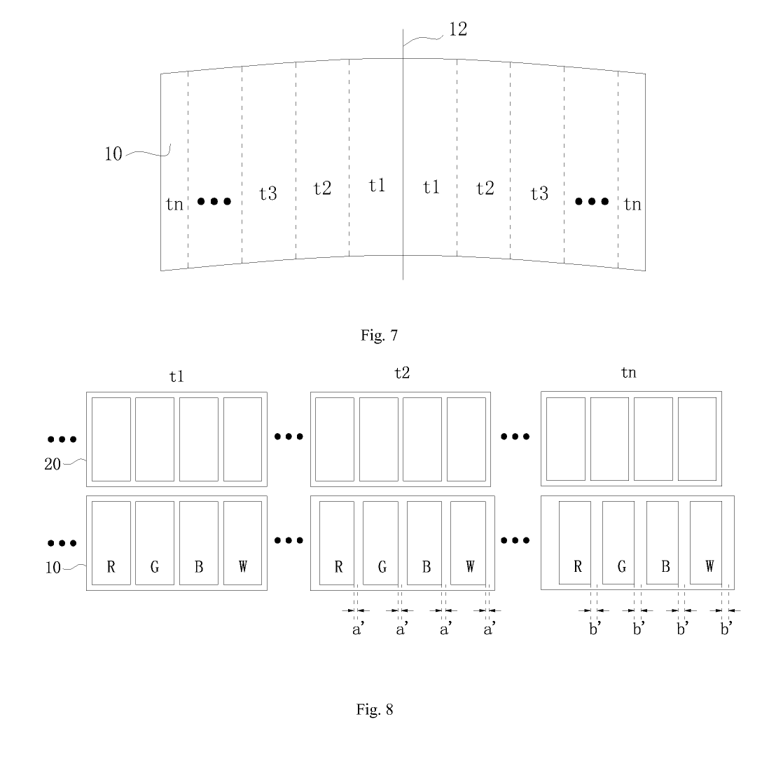

In the second embodiment, as shown in FIGS. 7 and 8, the RGBW pixel is taken as one example. The subpixels include a R-subpixel, a G-subpixel, a B-subpixel, and a W-subpixel arranged in parallel. The shift amount of the areas farther away from the vertical-central axis 12 of the CF substrate 10 may be smaller when the radius of the curvity is larger. A plurality of areas with a fixed width are defined from the vertical-central axis 12 toward two sides. The width of black matrix of the two areas t1, which are the areas closest to the vertical-central axis 12, remain the same. The width of the adjacent areas t2, which connect to the central area, increases accordingly. In fact, the increased amount “a” or “b” may be non-linear due to factors such as material, manufacturing process, and environment, but may be predicted. Taking the experimental results as one example, the width of the LCD is 1.2 m, the radius of the curvity is 5 m, the largest shift amount is 21.25 μm when the thickness of the glass equals to 0.7 mm is adopted. The largest shift amount is 14.96 μm when the thickness of the glass equals to 0.5 mm is adopted. That is, the largest amount of the black matrix is respectively 21.25 μm and 14.96 μm when the glasses with above thicknesses are manufactured to be the curved surface. In addition, the locations at which the optical compensation of the backlight sheet may be applied to may also be obtained by calculations.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A color filter (CF) substrate having black matrixes with variable widths, comprising:
the CF substrate is curved with black matrixes (BMs) arranged thereon, portions that are not covered by the BMs form subpixel display areas, wherein widths of the black matrixes increase gradually from a vertical-central axis of the CF substrate toward two sides of the CF substrate.

2. The CF substrate as claimed in claim 1, wherein widths of the subpixel display areas decrease gradually from a vertical-central axis of the CF substrate toward two sides of the CF substrate.

3. The CF substrate as claimed in claim 1, wherein a plurality of areas with a fixed width are defined on the CF substrate from the vertical-central axis toward two sides, the width of the black matrix of a central area where the vertical-central axis located and the width of the black matrix of an area closest to the vertical-central axis remain the same, the width of the black matrix of an adjacent area is greater than that of the central area by an amount equaling to “a”, and the width of the black matrix of one area is greater than that of the adjacent area closer to the central area by the amount equaling to “a.”

4. The CF substrate as claimed in claim 1, wherein the subpixels comprises R-subpixel, a G-subpixel, and a B-subpixel.

5. The CF substrate as claimed in claim 2, wherein the subpixels comprises R-subpixel, a G-subpixel, and a B-subpixel.

6. The CF substrate as claimed in claim 3, wherein the subpixels comprises R-subpixel, a G-subpixel, and a B-subpixel.

7. The CF substrate as claimed in claim 1, wherein the subpixels comprises R-subpixel, a G-subpixel, a B-subpixel, and a W-subpixel.

8. The CF substrate as claimed in claim 2, wherein the subpixels comprises R-subpixel, a G-subpixel, a B-subpixel, and a W-subpixel.

9. The CF substrate as claimed in claim 3, wherein the subpixels comprises R-subpixel, a G-subpixel, a B-subpixel, and a W-subpixel.

10. A liquid crystal device, comprising:
a curved color filter (CF) substrate, portions that are not covered by the BMs form subpixel display areas, wherein widths of the black matrixes increase gradually from a vertical-central axis of the CF substrate toward two sides of the CF substrate, and widths of the subpixel display areas decrease gradually from a vertical-central axis of the CF substrate toward two sides of the CF substrate.

11. The liquid crystal device as claimed in claim 10, wherein a plurality of areas with a fixed width are defined on the CF substrate from the vertical-central axis toward two sides, the width of the black matrix of a central area where the vertical-central axis located and the width of the black matrix of an area closest to the vertical-central axis remain the same, the width of the black matrix of an adjacent area is greater than that of the central area by an amount equaling to “a”, and the width of the black matrix of one area is greater than that of the adjacent area closer to the central area by the amount equaling to “a.”

12. The liquid crystal device as claimed in claim 10, wherein the liquid crystal device further comprises a backlight sheet arranged in a backside of a liquid crystal cell for applying optical compensation toward corresponding areas.

13. The liquid crystal device as claimed in claim 11, wherein the liquid crystal device further comprises a backlight sheet arranged in a backside of a liquid crystal cell for applying optical compensation toward corresponding areas.

14. The liquid crystal device as claimed in claim 10, wherein the subpixels comprises R-subpixel, a G-subpixel, and a B-subpixel.

15. The liquid crystal device as claimed in claim 11, wherein the subpixels comprises R-subpixel, a G-subpixel, and a B-subpixel.

16. The liquid crystal device as claimed in claim 10, wherein the subpixels comprises R-subpixel, a G-subpixel, a B-subpixel, and a W-subpixel.

17. The liquid crystal device as claimed in claim 11, wherein the subpixels comprises R-subpixel, a G-subpixel, a B-subpixel, and a W-subpixel.
